(19) United States
(12) Patent Application Publication
(10) Pub. No.: US 2016/0346949 A1
(43) Pub. Date: Dec. 1, 2016

(54) SLICING MACHINE FOR FOODSTUFFS IN BLOCK FORM

(71) Applicant: Rudi SILLER, Abstatt (DE)

(72) Inventor: Rudi SILLER, Abstatt (DE)

(21) Appl. No.: 15/114,498

(22) PCT Filed: Jan. 28, 2015
(86) PCT No.: PCT/DE2015/000030

§ 371 Date: Jul. 27, 2016

(30) Foreign Application Priority Data
Feb. 6, 2014 (DE) 10 2014 001 511.4

(51) Int. Cl. B26D 7/06; B26D 7/18; B26D 7/01; B26D 1/16

(52) U.S. Cl. CPC B26D 7/0641; B26D 1/16; B26D 7/0683; B26D 7/18; B26D 7/01; B26D 2007/0018

(57) ABSTRACT

A slicing machine for foodstuffs in block form has a slicing blade for the foodstuff in block form and a shaft for receiving the foodstuff. The longitudinal direction of the shaft corresponds to the feed direction of the foodstuff in block form. The shaft has a first shaft region and a second shaft region which are at least partially separated from one another by a slot. At least one offset lies between the two shaft regions. The two shaft regions can be moved relative to one another such that the offset can be reduced by the movement.

### TECHNICAL FIELD

The invention relates to a slicing machine with which bread, cheese and like foodstuffs in block form can be machine-cut into slices of optional thickness. The slicing machine according to the invention can be constituted, in particular, by a rotary blade machine.

### PRIOR ART

A rotary blade machine for cutting a block of foodstuff into slices is known from DE 198 20 004 C2. This slicing machine possesses a circular cutting blade, which can rotate about its center axis and can additionally be swiveled around in a circular path. In this swivel movement, it can be guided through the block-like foodstuff which is to be cut into slices. The block-like foodstuff is guided to the cutting blade in a channel-like shaft and cut up into slices. The channel-shaped shaft here runs in a roughly horizontal direction or a direction tilted slightly out of the horizontal. The cut slices are stored on a bearing surface arranged downstream of the cutting blade in the direction of feed.

The longitudinal direction of the shaft here corresponds to the longitudinal direction of the slicing machine; the block-like foodstuff is transported out of the view of the operator during the cutting operation, i.e. from left to right or from right to left. In horizontal slicing machines of this type, the removal of the cut foodstuff block therefore generally occurs at a different place than the insertion of the uncut foodstuff block. The width of the slicing machines is correspondingly large, since at least two foodstuff block lengths have to be accommodated in the slicing machine.

From DE 201 20 234 U1, a compact slicing machine in which the rotary blade is incrementally shifted during the cutting operation is known. As a result, the foodstuff to be cut can remain at the place at which it was inserted into the slicing machine. The shifting of the rotary blade is technically complex, however, so that the corresponding slicing machines are correspondingly dear.

From DE 93 10 092 U1 a rotary blade machine in which the shaft is oriented in the vertical direction or in a direction slightly inclined with respect to the vertical is known. The block-like foodstuff is guided from top to bottom past the cutting blade and, in the process, cut into slices. The cut foodstuff pack is subsequently moved back upward so as to be removed there from the slicing machine.

According to DE 44 31 808 C1, in an alternative embodiment of a vertical slicing machine the foodstuff block is firstly guided downward in an unsliced state. The cutting of the foodstuff block only takes place upon the upward movement.

Vertical slicing machines of this type can be of correspondingly narrower construction and consequently have a lesser spatial requirement. In order to achieve a high-quality cut, an offset between the shaft region before the cutting blade and the shaft region after the cutting blade is generally necessary, however. Such an offset would impede, however, the return of the cut slice pack, so that the removal of the cut slice pack would in this case have to take place beneath the cutting blade. A removal of the cut slice pack at this place would make it necessary, however, to stoop relatively low, which generally should not be expected of the sales staff or of the end customer in the self-service sector.

### REPRESENTATION OF THE INVENTION

Starting from this previously known prior art, the object of the invention is to define an improved slicing machine in which the insertion and removal of the foodstuff can take place at the same place and which nevertheless enables a high-quality cut.

The slicing machine according to the invention is given by the features of patent claim 1. An alternative embodiment of the slicing machine is given by the features of the co-ordinated patent claim 8. A cutting method according to the invention is given by the features of patent claim 12. Sensible refinements of the invention are the subject of further claims following on from patent claims 1, 8 and 12.

The slicing machine according to the invention possesses at least a cutting blade for the block-like foodstuff and a shaft for receiving the block-like foodstuff. The direction of feed of the block-like foodstuff corresponds to the longitudinal direction of the shaft. The shaft has a first shaft region before the cutting blade and a second shaft region after the cutting blade, which are at least partially separated from each other by a slot. In this slot, the cutting blade can rotate during the cutting operation. Between the first shaft region and the second shaft region, an offset is present. According to the invention, the first and the second shaft regions are movable relative to each other, so that the offset can be reduced after the completion of the cutting operation. As a result, the return of the cut slice pack can hence be realized reliably and without obstacles. In this way, the cut slice pack can be offered for removal at the place at which the uncut foodstuff block has been inserted into the slicing machine. In this context, it can be sufficient to configure only the first or the second shaft region movably. It would also be possible, however, to configure both shaft regions movably.

During the cutting operation, the first shaft region and the second shaft region, in a first position, are thus arranged, as before, mutually offset, so that a high-quality cut can be enabled. Preferably, the first and second shaft regions, in a second position—after the movement of the first and/or second shaft region—can be mutually aligned. In this case, the offset would be fully compensated. This second position can be assumed in particular during the return of the cut slice pack.

Alternatively or additionally thereto, the second shaft region, in this second position, can overlap at least in sections the first shaft region. In this way, the slot between the first and the second slot region can be closed off, so that an accidental touching of the cutting blade can be precluded. In this case, the second position of the two shaft regions can be assumed also in the rest position of the slicing machine i.e. during non-usage or during the insertion of the uncut foodstuff block.

This overlapping can be realized, for instance, by an (additional) movement of the second shaft region in the longitudinal direction of the shaft. An overlap can also be realized by the extension of additional crosspieces which close off the slot.

In the movement of the first and/or second shaft region, it is not necessary for the whole of the shaft region to be moved. Rather, it can be sufficient if only parts or regions of the respective shaft region are configured movably. For instance, in the region of the slot can be arranged respectively movably mounted crosspieces or plates, which can be used to compensate the offset or to form the overlap.

The movement of the first and/or second shaft region can be made as a rotary movement. For this purpose, the first and/or second shaft region can respectively be mounted rotatably about an axis. In the case of an angular configuration of the shaft regions, which shall frequently be found in the region of the slicing machines, the rotational axis can run through the respective edges of the shaft regions. Such an embodiment requires only a comparatively small design adaptation of the known slicing machines and can thus be realized in an economically favorable manner. The shaft regions can here be, in particular, of L-shaped configuration.

The edge of the first shaft region and the edge of the second shaft region can preferably be mutually aligned, so that a single rotational axis can be sufficient to be able to move both shaft regions. In addition, a full matching of the respective shaft regions can be achieved in a particularly simple manner.

Alternatively or additionally thereto, the first and/or second shaft region can be displaceably mounted. In this embodiment, the planes of the two shaft regions, in a first position, can be arranged parallel to each other, so that a uniform offset can be achieved in this position. Through a displacement of the first and/or second shaft region in the transverse direction to the direction of feed, this offset can be reduced, or completely compensated. In addition, through a displacement of the first and/or second shaft region in the longitudinal direction of the shaft, an overlap of the two shaft regions can be achieved.

Essentially, such a slicing machine according to the invention can be configured as a horizontal or as a vertical slicing machine. In a horizontal slicing machine also, advantages are obtained in respect of the required space for setting up the slicing machine, since the full width of the slicing machine no longer has to be freely accessible. Rather, that region of the slicing machine which lies behind the cutting blade can be “covertly” present, and can be concealed, for instance, by a storage rack for the foodstuffs to be cut.

In a particularly advantageous embodiment, the slicing machine according to the invention can be constituted by a vertical slicing machine, in which the longitudinal direction of the shaft is present in vertical orientation or in orientation slightly inclined with respect to the vertical. In this way, the slicing machine itself can be configured significantly narrower than a comparable horizontal slicing machine without compromises having to be accepted in the quality of the cut. Rather, a horizontal slicing machine can now also be equipped with an offset between two shaft regions, so that a good cutting result can be obtained.

In a further preferred embodiment, the longitudinal direction of the shaft can run roughly perpendicular to the longitudinal direction of the slicing machine. The longitudinal direction of the slicing machine here corresponds to the user-facing front side of the slicing machine. This does not necessarily have to be the longest side of the slicing machine. The foodstuff is hence no longer transported from left to right or from right to left, but rather from front to back or from back to front. Such a slicing machine would be constructed somewhat deeper than the slicing machines already known in the prior art, though, in return for this, significantly narrower. Since additional space is generally present in terms of the depth, by rotation of the direction of feed out of the longitudinal direction of the slicing machine, an overall reduction is made of the spatial requirement in the setting-up of the slicing machine. This embodiment of the slicing machine having a shaft running perpendicular to the longitudinal direction of the slicing machine is therefore also of independent inventive importance.

In this way, also in a horizontal orientation of the longitudinal direction of the shaft, or an orientation slightly inclined with respect to the horizontal, a very narrow and compact slicing machine, the width of which could correspond to a vertical slicing machine, can be realized. Since horizontal slicing machines have a greater presence on the market and thus a certain familiarization with the horizontal cutting direction has arisen, it can be advantageous, in particular where the slicing machine is operated directly by the end customers, if this horizontal cutting direction is maintained.

In an advantageous embodiment, a rotating device, by means of which the inserted foodstuff block can be rotated within the shaft plane, can be present in the insertion region of the slicing machine. As a result, the foodstuff block can be inserted by the operators of the slicing machine as usual with its longitudinal direction in the longitudinal direction of the slicing machine. Subsequently, the longitudinal direction of the foodstuff block can be rotated by the rotating device in the direction of feed of the foodstuff block. The cut foodstuff can also be rotated by means of this rotating device.

In such a slicing machine having such a direction of feed running in the transverse direction of the slicing machine, the transport slide could be disposed in the front region of the slicing machine, so that the foodstuff block is pushed rearward and is hereupon cut. After this, the cut foodstuff block would have to be pushed back forward by a further transport device.

In an advantageous embodiment, the transport slide can therefore be disposed at the rear end of the shaft. As a result, the transport slide can firstly be moved forward and can there grip the inserted foodstuff block. With the uncut foodstuff block, the transport slide can then move rearward past the cutting blade. Subsequently, the foodstuff block is once again pushed forward by the transport slide. During this movement, the cutting of the foodstuff block by the rotary blade takes place. In this way, the forward and the rearward movement can be realized by the same transport slide without the need for an additional transport element.

In the method according to the invention for cutting block-like foodstuffs by means of a slicing machine, the foodstuff is firstly inserted into a shaft of the slicing machine, wherein this shaft has two shaft regions, which are at least partially separated from each other by a slot. After this, the foodstuff is guided past the cutting blade in the direction of feed. Following completion of this movement, the relative position of the two shaft regions is altered and the foodstuff is subsequently once again guided past the cutting blade in a counter direction opposite to the direction of feed. The cutting of the block-like foodstuff can here take place in the first or second run past the cutting blade.

In this way, on the one hand a high-quality cutting result can be achieved, since, during the cutting operation, an offset of the two shaft regions can be set, which offset, in the course of the simple run past, can be reduced or completely compensated without a cutting operation. On the other hand, the removal of the cut foodstuff pack can take place at the same place at which also the insertion of the foodstuff block has taken place, so that a compact and thus space-saving construction of the slicing machine can be enabled. Such a method can be conducted, in particular, on an above-described slicing machine.

In order to allow the operators a simplest possible handling, the inserted foodstuff can be rotated within the shaft of the slicing machine prior to the first run past the cutting blade. The foodstuff can thus be inserted as usual, so that no refamiliarization has to take place. In addition, sensors could be used to check in what orientation the foodstuff block has been inserted, in order to preclude related operating errors.

Further advantages and features of the invention can be derived from the features further defined in the claims, and from the following illustrative embodiments.

### BRIEF DESCRIPTION OF THE DRAWING

The invention is described and explained in greater detail below with reference to the illustrative embodiments represented in the drawing, wherein

FIG. 1 shows a front view of a first embodiment of the slicing machine according to the invention, having a shaft, slightly inclined with respect to the vertical, for receiving the block-like foodstuff,

FIG. 2 shows a section along the line A-A according to FIG. 1,

FIG. 3 shows a detailed view of the transitional region between the two shaft regions according to FIG. 2,

FIG. 4 shows a top view of a second embodiment of the slicing machine according to the invention with horizontal shaft, the longitudinal direction of which is arranged roughly perpendicular to the longitudinal direction of the slicing machine, wherein a foodstuff is present in the insertion region,

FIG. 5 shows a top view of the slicing machine according to FIG. 4, in which the inserted foodstuff has been rotated, and

FIG. 6 shows a top view of the slicing machine according to FIG. 4, in which the inserted foodstuff has been transported rearward.

### WAYS TO IMPLEMENT THE INVENTION

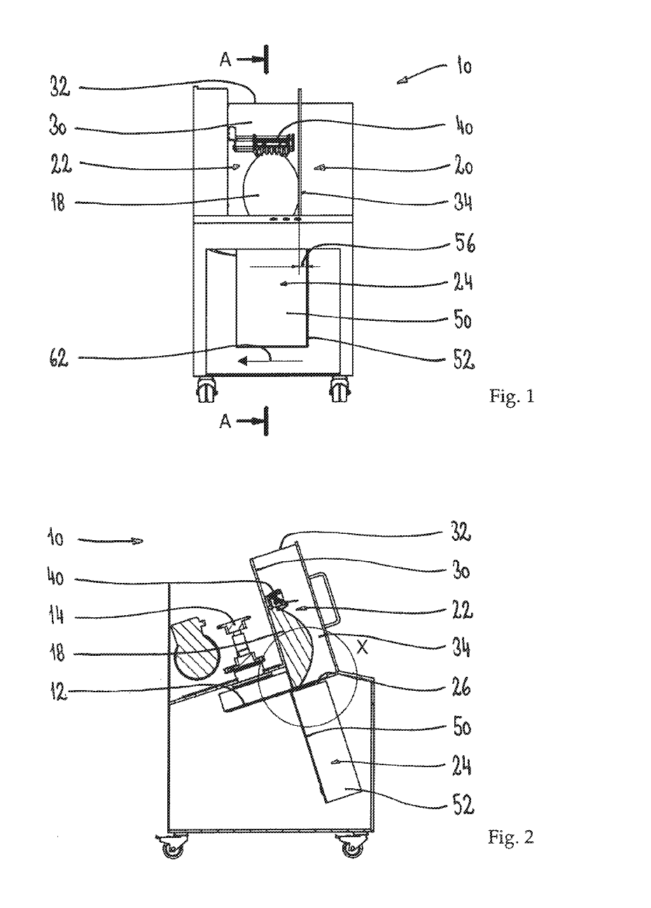

A first embodiment of the slicing machine 10 according to the invention is represented in FIGS. 1 to 3. In the present exemplary case, the slicing machine 10 is configured as a rotary blade machine having a circular blade 12. The circular blade 12 is coupled in the usual way to a blade drive 14, which provides for the rotation of the circular blade 12 and its movement through the foodstuff to be cut.

The slicing machine 10 possesses a shaft 20, the longitudinal direction of which corresponds to the direction of feed of an inserted block-like foodstuff 18. In the present exemplary case, the shaft 20 is present slightly inclined with respect to the vertical. The shaft 20 of the slicing machine 10 possesses a first, upper shaft region 22 and a second, lower shaft region 24, which are separated from each other by a slot 26. Driven by the blade drive 14, the circular blade 12 travels through this slot 26, so that the foodstuff 18 present in the region of the slot 26 is sliced at this place. In relation to the drawing, a foodstuff slice is then formed beneath this slot 26. Above the slot 26, the foodstuff 18 is present in a still unsliced state.

The foodstuff 18 to be sliced is placed in the upper shaft region onto the rear channel wall 30 thereof. In the present exemplary case, the rear channel wall 30 is present slightly inclined with respect to the vertical, the upper end 32 of the rear channel wall 30 being tilted rearward, so that the inserted foodstuff 18 does not fall out of the shaft 20. The rear channel wall 30 is present roughly at right angles to a side wall 34, which in the illustrative embodiment represented in the drawing is represented on the right. This side wall 34 could be arranged in a longitudinally displaceable manner on the rear channel wall 30, so that the width of the upper shaft region 22 could be variably adjusted by a certain amount in order to adapt the shaft width to the size of the inserted foodstuff 18.

For the slicing, the foodstuff block 18 is pushed by a transport slide 40 in the direction of the slot 26. The transport slide 40 can have, for instance, a plurality of mutually adjacent claws, which in the cutting operation dig sufficiently firmly into the end of the foodstuff from above.

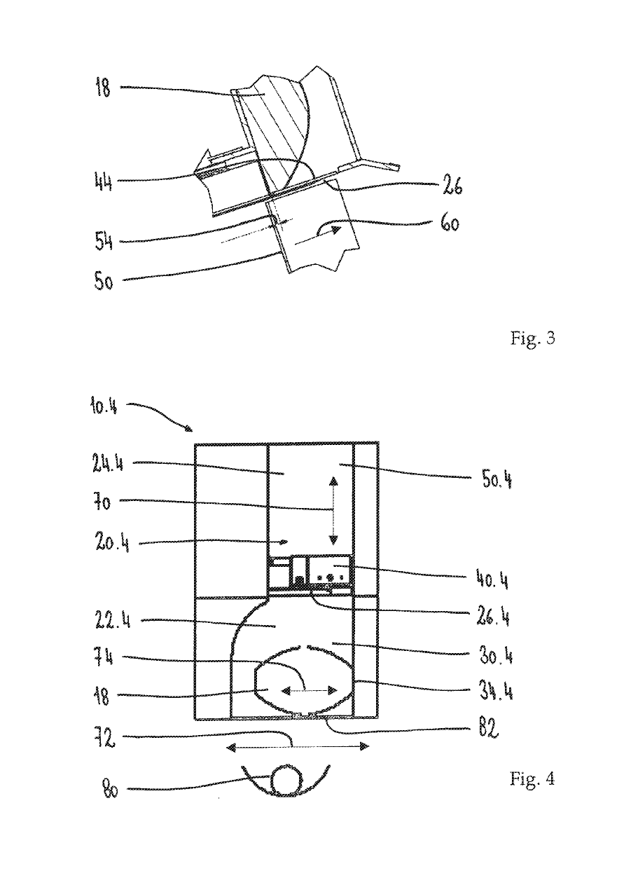

In order to prevent the cut slices of the foodstuff block 18 from falling down, a slice support 44 is arranged beneath the inserted foodstuff 18. Prior to the start of the cutting operation, the unsliced foodstuff 18 rests on this slice support 44 (see in particular FIG. 3). Parallel to the advancement of the transport slide 40, the slice support 44 also moves incrementally downward, so that the cut slices can rest on the slice support 44. In the represented illustrative embodiment, the slice support 44 and the transport slide 40 are thus coupled together.

The lower shaft region 24 likewise possesses a rear channel wall 50, which in the present exemplary case is present parallel to the rear channel wall 30 of the upper shaft region 22. Parallel to the side wall 34 of the upper shaft region 22, a side wall 52 of the lower shaft region 24 is present. In the lower shaft region 24, the cut slice pack is collected, wherein the rear channel wall 50, in conjunction with the slice support 44, provides for a secure storage of the slice pack.

In order to obtain a clean and high-quality cut by the circular blade 12, an offset 54 is present between the rear channel wall 30 of the upper shaft region 22 and the rear channel wall 50 of the lower shaft region 24. Between the side wall 34 of the upper shaft region 22 and the side wall 52 of the lower shaft region 24, an offset 56 is also present. This offset 54, 56 would get in the way when the slice support 44 is raised, since the slice pack can bang against the offset 54, 56, which can result in damage to the cut slices or toppling of the slice pack.

For this reason, in the present exemplary case the lower shaft region 24 is configured movably. After the completion of the cutting operation, the lower shaft region 24 can be displaced somewhat in the transverse direction (arrow 60) in order to compensate the offset 54. At the same time, the lower shaft region 24 can be displaced somewhat in the transverse direction of the side wall (arrow 62) in order also to be able to compensate the offset 56. Ideally, the upper shaft region 22 can thus be aligned with the lower shaft region 24.

In addition thereto, a further movement of the lower or the upper shaft region could also be made in the longitudinal direction of the shaft region, so that the lower shaft region would somewhat overlap the upper shaft region. In this case, the slot 26 would be fully closed off.

In contrast to the illustrative embodiment which is represented here, the offset between the upper and the lower shaft region could also be reduced by a rotation of one of the two shaft regions.

A second embodiment of the slicing machine 10.4 according to the invention is represented in FIGS. 4 to 6. The slicing machine 10.4, like also the slicing machine 10, is configured as a rotary blade machine. The slicing machine 10.4 possesses a shaft 20.4, the longitudinal direction 70 of which corresponds to the direction of feed of the inserted block-like foodstuff 18. In the present exemplary case, the shaft 20.4 is present roughly horizontally. However, the longitudinal direction 70 of the shaft 20 is present roughly perpendicular to the longitudinal direction of the slicing machine 10.4, so that the longitudinal direction 70 of the shaft 20.4 corresponds to the transverse direction of the slicing machine 10.4.

The shaft 20.4 of the slicing machine 10.4 possesses a first, front shaft region 22.4 and a second, rear shaft region 24.4, which are separated from each other by a slot 26.4. Driven by the blade drive 14, the circular blade 12 travels through this slot 26.4, so that the foodstuff 18 present in the region of the slot 26.4 is sliced at this place.

The foodstuff 18 to be sliced can be inserted from the front side 82 of the slicing machine 10.4 by an operator 80, who can be a member of the sales staff or an end customer. The foodstuff 18 to be sliced is placed in the front shaft region 22.4 onto its lower channel wall 30.4. The lower channel wall 30.4 is present roughly at right angles to a side wall 34.4, which in the illustrative embodiment represented in the drawing is represented on the right. This side wall 34.4 could be arranged in a longitudinally displaceable manner on the lower channel wall 30.4, so that the width of the front shaft region 22.4 could be variably adjusted by a certain amount in order to adapt the shaft width to the size of the inserted foodstuff 18.

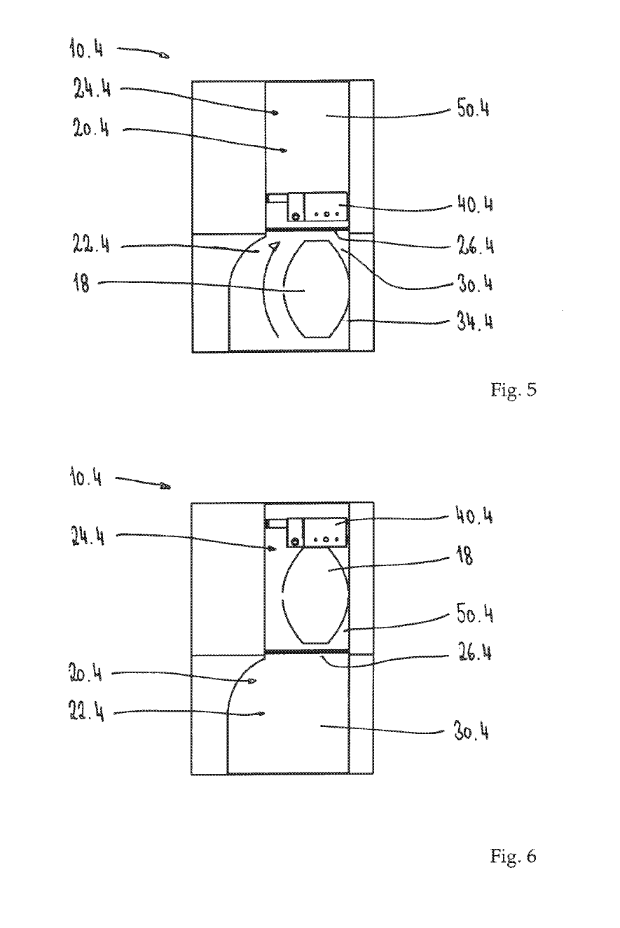

The longitudinal axis 74 of the inserted foodstuff 18 should generally be oriented within the longitudinal axis 70 of the shaft 20.4, and thus in the direction of feed. A foodstuff 18, which according to FIG. 4 has been inserted in a different orientation, can therefore firstly be rotated such that its longitudinal axis 74 lies according to FIG. 5 within the longitudinal axis 70 of the shaft 20.4.

For the slicing, the foodstuff block 18 is drawn by a transport slide 40.4, firstly over the slot 26.4, rearward onto the second, rear shaft region 24.4. For this purpose, the transport slide 40.4 has a plurality of mutually adjacent claws, which dig sufficiently firmly into the end of the foodstuff 18 from above. In this run past the circular blade 12, initially no cutting operation takes place. The front shaft region 22.4 and the rear shaft region 24.4 are here arranged in such a way relative to each other that the respective lower channel walls 30.4 and 50.4 are mutually aligned.

After this, the foodstuff 18 is pushed by the transport slide 40.4 once again past the circular blade 12. In this second run past, the cutting of the foodstuff 18 takes place. The cut foodstuff block can then be rotated back again in accordance with FIG. 5 to enable it to be comfortably removed from the front shaft region 22.4.

1-13. (canceled)

14. A slicing machine (10.4) for block-like foodstuffs (18),
comprising a circular blade (12) for the block-like foodstuff (18),
comprising a shaft (20.4) for receiving the block-like foodstuff (18), the longitudinal direction (70) of which corresponds to the direction of feed of the block-like foodstuff (18),
wherein the shaft (20.4) has a first shaft region (22.4) and a second shaft region (24.4), which are at least partially separated from each other by a slot (26.4),
wherein the longitudinal direction (70) of the shaft (20.4) runs roughly perpendicular to the longitudinal direction (72) of the slicing machine (10.4),
wherein the longitudinal direction of the slicing machine corresponds to the user-facing front side of the slicing machine, and
wherein the longitudinal direction (70) of the shaft (20.4) is present in horizontal orientation or in orientation slightly inclined with respect to the horizontal.

15. The slicing machine as claimed in claim 14, wherein
a rotating device, by means of which the inserted foodstuff block (18) is rotatable within the shaft plane, is present in the insertion region of the slicing machine (10.4).

16. The slicing machine as claimed in claim 14, wherein
a transport slide (40.4) is disposed at the rear end of the shaft.

17. A slicing machine as claimed in claim 14,
wherein, between the first shaft region (22.4) and the second shaft region (24.4), at least an offset (54, 56) is present, wherein
the first shaft region (22.4) and the second shaft region (24.4) are movable relative to each other such that the offset (54, 56) is reducible by the movement.

18. The slicing machine as claimed in claim 17, wherein
the first shaft region (22.4) and the second shaft region (24.4), in a first position, are arranged mutually offset, and
the first shaft region (22.4) and the second shaft region (24.4), in a second position, are mutually aligned.

19. The slicing machine as claimed in claim 17, wherein
the first shaft region (22) and the second shaft region (24), in a first position, are arranged mutually offset, and
the second shaft region (24), in a second position, overlaps at least in sections the first shaft region (22).

20. The slicing machine as claimed in claim 17, wherein
the first shaft region (22) and/or the second shaft region (24) is or are mounted rotatably about an axis.

21. The slicing machine as claimed in claim 17, wherein
the first shaft region (22) and/or the second shaft region (24) are displaceably mounted.

22. A method for cutting block-like foodstuffs by means of a slicing machine, comprising the following method steps:
the block-like foodstuff is inserted into a shaft of the slicing machine, wherein the shaft has two shaft regions, which are at least partially separated from each other by a slot,
the block-like foodstuff is guided past a cutting blade in the direction of feed,
the relative position of the two shaft regions one to the other is altered,
the block-like foodstuff is once again guided past the cutting blade in the opposite direction of feed,
wherein the cutting of the block-like foodstuff takes place in the first or second run past the cutting blade.

23. The method as claimed in claim 22, wherein
the inserted foodstuff block is rotated within the shaft prior to the first run past the cutting blade.
